(19) United States
(12) Patent Application Publication
(10) Pub. No.: US 2013/0148205 A1
(43) Pub. Date: Jun. 13, 2013

(54) METHOD OF PRODUCING ANTIREFLECTION FILM

(71) Applicant: CANON KABUSHIKI KAISHA, Tokyo (JP)

(72) Inventors: Motokazu Kobayashi, Yokohama-shi (JP); Yoji Teramoto, Ebina-shi (JP); Hiroyuki Tanaka, Kawasaki-shi (JP); Yu Kameno, Yokohama-shi (JP)

(73) Assignee: CANON KABUSHIKI KAISHA, Tokyo (JP)

(21) Appl. No.: 13/686,350

(22) Filed: Nov. 27, 2012

(30) Foreign Application Priority Data
Dec. 12, 2011 (JP) 2011-271394

(51) Int. Cl. G02B 1/11

(52) U.S. Cl. CPC G02B 1/11
USPC 359/601; 427/558

(57) ABSTRACT

Provided are a method of producing an antireflection film having a low reflectance, the film using hollow particles having good shape uniformity, and a lens. The method includes: applying, onto the base material, a dispersion containing core-shell particles each using an organic polymer as a core and silica as a shell; drying the dispersion to form a film containing the core-shell particles; and removing the organic polymer through irradiation of the film containing the core-shell particles with ultraviolet light to turn the core-shell particles into hollow particles.

### BACKGROUND OF THE INVENTION

1. Field of the Invention

The present invention relates to a method of producing an antireflection film, in particular, a method of producing an antireflection film having a low reflectance.

2. Description of the Related Art

When a lens, a film, or the like is used as an optical element, the following contrivance for reducing reflection has been made heretofore. The light transmittance of the element is increased by processing its surface. Available as a method of reducing reflection is, for example, a method called an anti-glare treatment involving: providing fine irregularities for a surface that is to be prevented from causing reflection; and scattering a reflected image through light scattering to blur its outline. However, the method is unsuitable for a lens or the like because the resolution of the image reduces.

The following method is also available. One or more thin films each having a thickness close to the wavelength of light (hereinafter, referred to as “antireflection film”) are laminated on a surface that is to be prevented from causing reflection, and then the reflection is reduced by a light interference effect. The method is frequently employed in a precision equipment such as a lens because the resolution of an image does not reduce.

When a base material is provided with such antireflection film, the reflectance of the base material, which has a reflectance of 4 to 5% before the treatment, can be suppressed to 0.5% or less.

When a single antireflection film is used, a film formed of a low-refractive index material is preferably selected. It has been known that when the top of a base material having a refractive index of, for example, A is coated with a material having a refractive index of √A so that a film of the material may have an optical thickness of λ/4 (where λrepresents a design wavelength), the reflectance of the resultant becomes theoretically zero.

In addition, when multiple thin films having different refractive indices are laminated, a low-refractive index material and a high-refractive index material are alternately laminated, and a material having the lowest refractive index is provided as an outermost layer.

A dry film-forming method such as sputtering or vapor deposition, or a wet film-forming method involving utilizing a chemical reaction such as a sol-gel method has been known as a method of forming the low-refractive index material, e.g., MgF₂ (having a refractive index of 1.38) or SiO₂ (having a refractive index of 1.45) into a film.

When an additionally low refractive index is needed, it is effective to utilize air having a refractive index of 1.0. For example, the following method is available. A hollow particle having a void in its inside is produced and then the hollow particle is formed into a film on the surface of a base material to reduce its refractive index. In the method, the refractive index can be changed according to a ratio between air and a material for the particle.

For example, various methods of producing a hollow particle having a diameter of about 50 to 200 nm, the particle using silica as its shell and having a void in its core (inside), have been known (Japanese Patent Application Laid-Open No. 2009-234854 and Japanese Patent Application Laid-Open No. 2008-201908). The refractive index can be reduced according to a ratio of the void. When silica is used as the shell, setting the ratio of the void in each of the core and the film to about 50% can reduce the refractive index to about 1.23.

Recently, however, hollow particles having additionally small particle diameters and a narrow particle diameter distribution have started to be required in order that an improvement in performance of an optical element may be achieved.

Japanese Patent Application Laid-Open No. 2009-234854 describes a method involving: adhering silica to the peripheries of inorganic fine particles made of calcium carbonate or the like as cores to produce core-shell particles; and then removing calcium carbonate as a core with nitric acid to produce hollow particles. In the method, the shapes of the calcium carbonate particles as the cores are not spherical and are nonuniform, and hence the shapes of the produced hollow particles are also nonuniform. The use of the hollow particles of such shapes is expected to be responsible for the occurrence of scattering because the use impairs surface smoothness at the time of film formation.

Japanese Patent Application Laid-Open No. 2008-201908 describes a method involving: adhering silica to the peripheries of high-molecular weight fine particles made of a polystyrene, a polymethyl methacrylate, or the like as cores to produce core-shell particles; and then dissolving and removing the high-molecular weight fine particles as the cores with an organic solvent. The high-molecular weight fine particles can be synthesized in shapes having a narrow particle diameter distribution and close to spheres, and hence particles each having good sphericity can be produced until silica is adhered. However, the dissolution and removal of the organic fine particles with the organic solvent after the adhesion hardly progress, and hence a particle that is not hollow (solid particle) or such a hollow particle that part of a high-molecular weight fine particle remains at its central portion has existed. The existence of such solid particle or such hollow particle that part of a high-molecular weight fine particle remains causes an increase in refractive index, with the result that an increase in reflectance occurs.

Also available is a method involving applying heat at 400° C. or more and the high-molecular weight fine particles after the adhesion of silica to calcine the particles. In the method, the high-molecular weight fine particles are removed with reliability and hence hollow particles are produced. However, the hollow particles agglomerate to make their re-dispersion difficult, and hence film formation cannot be performed. Although a method involving forming the particles after the adhesion of silica into a film on a base material and heating the film to 400° C. or more is available, the method has not been preferred because the deterioration of the base material and a peripheral member provided for the base material in advance such as a high-refractive index material or a light-shielding material occurs.

The present invention has been made in view of such background art and provides a method of producing an antireflection film having a low reflectance, the film using hollow particles having good shape uniformity.

### SUMMARY OF THE INVENTION

A method of producing an antireflection film for solving the above-mentioned problem is a method of producing an antireflection film provided on a base material, the method including: applying, onto the base material, a dispersion containing core-shell particles each using an organic polymerorganic polymer as a core and silica as a shell; drying the dispersion to form a film containing the core-shell particles; and removing the organic polymerorganic polymer through irradiation of the film containing the core-shell particles with ultraviolet light to turn the core-shell particles into hollow particles.

Another method of producing an antireflection film for solving the above-mentioned problem is a method of producing an antireflection film provided on a base material, the method including: applying, onto the base material, a dispersion containing core-shell particles each using an organic polymerorganic polymer as a core and silica as a shell; drying the dispersion to form a film containing the core-shell particles; removing the organic polymer through irradiation of the film containing the core-shell particles with ultraviolet light to turn the core-shell particles into hollow particles; and applying a solution containing a component needed for forming a binder to fill a gap between the hollow particles with the binder.

According to the present invention, it is possible to provide the method of producing an antireflection film having a low reflectance, the film using hollow particles having good shape uniformity.

Further features of the present invention will become apparent from the following description of exemplary embodiments with reference to the attached drawings.

### BRIEF DESCRIPTION OF THE DRAWINGS

FIG. 1 is an explanatory diagram illustrating an example of an optical element having an antireflection film produced by a production method of the present invention.

FIG. 2 is an explanatory diagram illustrating another example of the optical element having the antireflection film produced by the production method of the present invention.

FIG. 3 is an explanatory diagram illustrating an optical element having an antireflection film produced by Example 2 of the present invention.

### DESCRIPTION OF THE EMBODIMENTS

Hereinafter, an embodiment of the present invention is described.

A first method of producing an antireflection film according to the present invention includes the steps of: applying, onto a base material, a coating liquid containing core-shell particles each using an organic polymer as a core and silica as a shell; drying the coating liquid to form a film containing the core-shell particles; and removing the organic polymer through the irradiation of the film containing the core-shell particles with ultraviolet light to turn the core-shell particles into hollow particles.

First, the step of applying, onto the base material, the coating liquid containing the core-shell particles each using the organic polymer as the core and silica as the shell is described.

In a method of producing the core-shell particles, organic polymer fine particles are each used as the core formed of the organic polymer.

The composition of each of the organic polymer fine particles (hereinafter, sometimes abbreviated as high-molecular weight fine particles) serving as the cores is not limited, and there may be used, for example, fine particles of a polystyrene, a polybutyl acrylate, a polybutadiene, a butyl acrylate-butadiene copolymer, a butyl acrylate-styrene copolymer, a butyl acrylate-acrylonitrile copolymer, a butyl acrylate-styrene-acrylonitrile copolymer, a styrene-acrylonitrile copolymer, or the like.

A method of producing the organic polymer fine particles is not particularly limited, and there may be employed a known method such as an emulsion polymerization method, a microsuspension polymerization method, a microemulsion polymerization method, or an aqueous dispersion polymerization method.

The average particle diameter of the high-molecular weight fine particles is preferably about 10 nm to about 100 nm. An average particle diameter of less than nm is not preferred because it becomes difficult to produce the high-molecular weight fine particles. An average particle diameter in excess of 100 nm is also not preferred because when the fine particles are used in an antireflection film, the extent of scattering at the surface of the antireflection film enlarges.

A radical polymerization initiator is used for the polymerization of the high-molecular weight fine particles. Specific examples of the radical polymerization initiator include: organic peroxides such as cumene hydroperoxide, t-butyl hydroperoxide, benzoyl peroxide, t-butylperoxyisopropyl carbonate, and paramenthane hydroperoxide; inorganic peroxides such as potassium persulfate and ammonium persulfate; and azo compounds such as 2,2’-azobisisobutyronitrile, 2,2′-azobis-2,4-dimethylvaleronitrile, and azobisisobutyramidine dihydrochloride.

As an emulsifier which may be used in the production of the high-molecular weight fine particles, there may be used an anionic, cationic, or nonionic emulsifier. Specific examples of the anionic emulsifier include a sodium alkylbenzenesulfonate, sodium lauryl sulfonate, and potassium oleate. Specific examples of the cationic emulsifier include hexadecyltrimethylammonium bromide, distearyldimethylammonium chloride, and benzalkonium chloride. Specific examples of the nonionic emulsifier include polyoxyethylene nonylphenyl ether and polyoxyethylene lauryl ether.

The peripheries of the high-molecular weight fine particles serving as the cores produced by the method are coated with silica serving as the shell to provide the core-shell particles.

In the method of producing the core-shell particles, a coating layer is formed by subjecting a compound represented by the following general formula (1) (hereinafter, sometimes referred to as “compound 1”) to hydrolysis condensation with a dispersion body containing the high-molecular weight fine particles to serve as the cores and an aqueous dispersion medium in the presence of an acid catalyst or a basic catalyst to deposit silica on the surface of each of the high-molecular weight fine particles. Here, a reaction temperature in the hydrolysis condensation is 0 to 100° C., preferably 20 to 80° C. A reaction time is 30 to 1,000 minutes, preferably 30 to 300 minutes.

R¹ₘSi(OR²)₄₋ₘ (1)

(In the formula, R¹ and R² each independently represent a monovalent organic group, and m represents an integer of 0 to 3.)

In the general formula (1), examples of the monovalent organic group represented by each of R¹ and R² include an alkyl group, an alkenyl group, an aryl group, an allyl group, and a glycidyl group. The monovalent organic group represented by R¹ is preferably an alkyl group or a phenyl group.

The alkyl group is preferably an alkyl group having 1 to 5 carbon atoms, and examples thereof include a methyl group, an ethyl group, a propyl group, and a butyl group. Each of these alkyl groups may be linear or branched, and a hydrogen atom thereof may be substituted by a fluorine atom or the like. Examples of the aryl group include a phenyl group, a naphthyl group, a methylphenyl group, an ethylphenyl group, a chlorophenyl group, a bromophenyl group, and a fluorophenyl group. Examples of the alkenyl group include a vinyl group, a propenyl group, 3-butenyl group, 3-pentenyl group, and 3-hexenyl group.

Specific examples of the compound 1 in the case of m=0 include tetramethoxysilane, tetraethoxysilane, tetra-n-propoxysilane, tetra-iso-propoxysilane, tetra-n-butoxysilane, tetra-sec-butoxysilane, tetra-tert-butoxysilane, and tetraphenoxysilane. One kind of those compounds may be used alone, or two or more kinds thereof may be simultaneously used.

Specific examples of the compound 1 in the case of m=1 to 3 include methyltrimethoxysilane, methyltriethoxysilane, methyltri-n-propoxysilane, methyltriisopropoxysilane, methyltri-n-butoxysilane, methyltri-sec-butoxysilane, phenyltri-n-propoxysilane, phenyltriisopropoxysilane, phenyltri-n-butoxysilane, phenyltri-sec-butoxysilane, di-n-butyldimethoxysilane, di-n-butyldiethoxysilane, and di-n-butyldi-n-propoxysilane. One kind of those compounds may be used alone, or two or more kinds thereof may be simultaneously used.

In order to accelerate the hydrolysis condensation of the compound represented by the general formula (1), silicic acid, and silicate, it is preferred that an acid catalyst or a basic catalyst be used in the hydrolysis condensation.

Examples of the acid catalyst and the basic catalyst, which may be used in the present invention, include sulfonic acids such as an aliphatic sulfonic acid, an aliphatic-substituted benzenesulfonic acid, and an aliphatic-substituted naphthalenesulfonic acid, amino acids, sulfuric acid, hydrochloric acid, nitric acid, sodium hydroxide, and potassium hydroxide.

The thickness of silica with which the peripheries are coated is preferably 1 nm to 20 nm. In the case where the thickness is smaller than 1 nm, the strength of each of the hollow particles after the removal of the high-molecular weight fine particles is so low that the particles are not practical. In addition, the case where the thickness is larger than 20 nm is not preferred because the percentage of voids in the hollow particles reduces and hence an increase in refractive index occurs.

The core-shell particles thus produced are dispersed in a dispersion medium to produce a dispersion (coating liquid). After that, the dispersion (coating liquid) is applied onto the base material. Water, an organic solvent, or the like is used as the dispersion medium and the dispersion medium may be selected according to the base material to which the dispersion is applied.

Specific examples of the organic solvent include methanol, ethanol, n-propanol, i-propanol, n-butanol, i-butanol, sec-butanol, t-butanol, n-pentanol, i-pentanol, 2-methylbutanol, sec-pentanol, t-pentanol, 3-methoxybutanol, n-hexanol, 2-methylpentanol, sec-hexanol, 2-ethylbutanol, sec-heptanol, 3-heptanol, n-octanol, 2-ethylhexanol, ethylene glycol monomethyl ether, ethylene glycol monoethyl ether, ethylene glycol monopropyl ether, ethylene glycol monobutyl ether, ethylene glycol monohexyl ether, ethylene glycol monophenyl ether, ethylene glycol mono-2-ethylbutyl ether, xylene, toluene, acetone, methyl ethyl ketone, and methyl isobutyl ketone.

In addition to the core-shell particles, a component needed for forming a binder may be added to the dispersion (coating liquid) for improving adhesiveness. Specific preferred examples of the component needed for forming a binder include inorganic materials such as a silica-based material exemplified in the general formula (1) and alumina. One kind of those materials is used alone, or two or more kinds thereof are used in combination.

In addition, a surfactant, a defoaming agent, a water-repellent agent, or the like may be simultaneously used.

The component needed for forming a binder, the surfactant, the defoaming agent, and the water-repellent agent may be used after the step of removing the cores from the core-shell particles to provide the hollow particles to be described later for the following purpose. Such materials are caused to permeate a gap between the hollow particles to: improve their adhesion; or impart a function.

The content of the core-shell particles to be incorporated into the dispersion (coating liquid) is desirably 0.5 wt % or more and 50 wt % or less, preferably 1 wt % or more and 40 wt % or less. The reasons for the foregoing are as described below. A content of less than 0.5 wt % is not preferred because the concentration of the core-shell particles is so low that the dispersion cannot be sufficiently applied to the base material to be described later or the application needs to be repeated again and again until a desired thickness is achieved. A content in excess of 50 wt % is also not preferred because, in contrast, the thickness increases or the dispersion (coating liquid) has so high a viscosity as to be unsuitable for the application.

A method for the application is not particularly limited, and there can be used a usual application method for a coating liquid in a liquid state, such as a dip coating method, a spin coating method, a spray coating method, or a roll coating method. The number of times of application is preferably 1 usually, whereas a plurality of times of drying and application may be repeated.

As a material for the base material, there may be used glass, a resin, and the like. Examples of the glass may include FC5, FCD1, FCD10, and LAC7 (all of which are manufactured by HOYA CORPORATION), N-SK4, N-SK5, N-SK10, and N-LAK10 (all of which are manufactured by SCHOTT AG). As the resin, there can be used a plastic formed of urethane acrylate, methacrylate, polyethylene terephthalate, cellulose, or the like and having a refractive index of 1.5 or more.

The shape of the base material is not limited, and any of a flat shape, a curved shape, a concave shape, a convex shape, a lump shape, and a film shape is acceptable. It is preferred that the base material be a lens, a film, or the like.

A method involving laminating one or more optical films each having a refractive index of 1.30 or more on the base material and applying the dispersion (coating liquid) containing the core-shell particles onto the laminated optical films may be employed.

One or more layers including a high-refractive index layer, a medium-refractive index layer, and the like may be provided as the optical films each having a refractive index of 1.30 or more. Each of the high-refractive index layer and the medium-refractive index layer can specifically include zirconium oxide, titanium oxide, tantalum oxide, lanthanum oxide, hafnium oxide, niobium oxide, magnesium fluoride, silica, or the like.

The high-refractive index layer and the medium-refractive index layer can be formed by using, for example, a vapor deposition method, a sputtering method, a CVD method, a dip coating method, a spin coating method, a spray coating method, or a roll coating method.

After the application, the solvent is removed by drying the dispersion (coating liquid) in which the core-shell particles have been dispersed. A drier, a hot plate, an electric furnace, or the like can be used in the drying. A temperature for the drying is preferably such a temperature and time that the base material is not affected. In general, the temperature is preferably 70° C. or more and 200° C. or less.

The thickness of the film containing the core-shell particles thus obtained, which is determined by, for example, the kind of the base material, and the kind and thickness of the high-refractive index layer or medium-refractive index layer between the base material and each core-shell particle, is preferably about 50 nm to about 200 nm in most cases.

Next, the step of removing the organic polymer as a core through the irradiation of the film containing the core-shell particles with ultraviolet light to turn the core-shell particles into the hollow particles is performed.

In the step of removing the organic polymer as a core after the application and drying of the core-shell particles, the organic polymer as a core is decomposed and removed to the outside of the system by irradiating the applied core-shell particles with the ultraviolet light. As a result, the hollow particles are produced.

A light source for the ultraviolet light to be used in the irradiation is preferably a light source that applies ultraviolet light having a wavelength of 200 nm or more and 365 nm or less. A metal halide lamp, an excimer lamp, a deep UV lamp, a low-pressure mercury lamp, or a high-pressure mercury lamp can be used.

When the high-molecular weight fine particles as the cores of the core-shell particles are irradiated with the ultraviolet light, the organic polymer is decomposed into a monomer and then the monomer penetrates through a gap in the shell of silica as a shell to be removed to the outside of the system. As a result, a core portion becomes a void and hence a hollow particle is produced.

With regard to the quantity of the ultraviolet light with which the film is irradiated, the film has only to be irradiated with the ultraviolet light for about 10 minutes to 2 hours as long as the ultraviolet light has a power of about 20 mW/cm² at a wavelength of, for example, 254 nm.

In addition, the core-shell particles may be heated in order that the decomposition of the organic polymer as a core may be promoted at the time of the irradiation with the ultraviolet light. A temperature for the heating is not particularly limited as long as none of the base material, the high-refractive index layer, the medium-refractive index layer, the peripheral member, and the like deteriorates. However, the irradiation with the ultraviolet light is preferably performed in a state where the base material is held at a temperature of 100° C. or more and 200° C. or less.

In addition, a second method of producing an antireflection film according to the present invention is a method of producing an antireflection film provided on a base material, the method including the steps of: applying, onto the base material, a dispersion containing core-shell particles each using an organic polymer as a core and silica as a shell; drying the dispersion to form a film containing the core-shell particles; removing the organic polymer through the irradiation of the film containing the core-shell particles with ultraviolet light to turn the core-shell particles into hollow particles; and applying a solution containing a component needed for forming a binder to fill a gap between the hollow particles with the binder.

The second method of producing an antireflection film further includes the step of applying the solution containing the component needed for forming the binder to fill the gap between the hollow particles with the binder in addition to the steps of the first method of producing an antireflection film.

Specific examples of the component needed for forming the binder include high-molecular weight resins such as a polyvinyl alcohol, a polyethylene oxide, a polyacrylamide, a sodium polyacrylate, a polyvinylpyrrolidone, a polycaprolactam, a polymethyl methacrylate, vinyl acetate, celluloses, a maleic acid resin, a diene-based polymer, an acrylic polymer, a melamine resin, a urea resin, a polyurethane resin, an unsaturated polyester resin, a polyvinyl butyral, and an alkyd resin. Further, an inorganic material such as the silica-based material exemplified in the general formula (1) or alumina may be used. One kind of those components is used alone, or two or more kinds thereof are used in combination.

In addition, a surfactant, a defoaming agent, a water-repellent agent, or the like may be simultaneously used.

In addition, the gap between the hollow particles is filled with the binder by a method involving: dissolving or dispersing the component needed for forming the binder in an organic solvent, water, or the like to produce a solution (coating liquid); applying the solution to the surfaces of the hollow particles; and drying and calcining the solution. A spin coating method, a dip coating method, a spray coating method, a roll coating method, or the like can be employed as a method for the application.

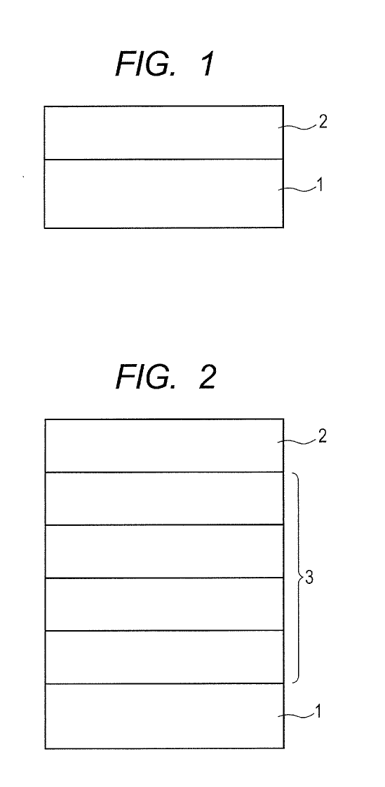

An optical element can be obtained by employing the method of producing an antireflection film of the present invention. FIG. 1 is an explanatory diagram illustrating an example of an optical element having an antireflection film produced by the production method of the present invention. Reference numeral 1 represents a base material and reference numeral 2 represents an antireflection film containing hollow particles formed by the first method of producing an antireflection film of the present invention. In other words, the antireflection film contains hollow particles formed as described below. A dispersion (coating liquid) containing core-shell particles each using an organic polymer as a core and silica as a shell is applied, and then the dispersion (coating liquid) is dried to form a film containing the core-shell particles. After that, the core-shell particles are turned into the hollow particles by irradiating the film containing the core-shell particles with ultraviolet light to remove the organic polymer. Further, a gap between the hollow particles may be filled with a binder by applying a solution containing a component needed for forming the binder.

In addition, FIG. 2 is an explanatory diagram illustrating another example of the optical element having the antireflection film produced by the production method of the present invention. As in the first embodiment, reference numeral 1 represents a base material and reference numeral 2 represents an antireflection film containing hollow particles formed by the first method of producing an antireflection film of the present invention. In other words, the antireflection film contains hollow particles formed as described below. A dispersion (coating liquid) containing core-shell particles each using an organic polymer as a core and silica as a shell is applied, and then the dispersion (coating liquid) is dried to form a film containing the core-shell particles. After that, the core-shell particles are turned into the hollow particles by irradiating the film containing the core-shell particles with ultraviolet light to remove the organic polymer. Further, a gap between the hollow particles may be filled with a binder by applying a solution containing a component needed for forming the binder. Reference numeral 3 represents one or more laminated optical films each having a refractive index of 1.30 or more.

The shape of the base material 1 is not limited, and any of a flat shape, a curved shape, a concave shape, a convex shape, a lump shape, and a film shape is acceptable. It is preferred that the base material 1 be a lens, a film, or the like.

One or more layers including a high-refractive index layer, a medium-refractive index layer, and the like may be provided as the optical films 3 each having a refractive index of 1.30 or more. Each of the high-refractive index layer and the medium-refractive index layer can specifically include zirconium oxide, titanium oxide, tantalum oxide, lanthanum oxide, hafnium oxide, niobium oxide, magnesium fluoride, silica, or the like.

Each of the optical elements illustrated in FIG. 1 and FIG. 2 obtained by employing the first method of producing an antireflection film of the present invention has formed therein a film containing hollow particles having good shape uniformity, has a low reflectance, and expresses extremely excellent optical characteristics.

The present invention is hereinafter described specifically by way of examples. However, the present invention is not limited to these examples.

### PRODUCTION EXAMPLE 1

A production example of core-shell particles is described. Core-shell particles to be used in the present invention were produced as described below.

0.2 Gram of cetyltrimethylammonium bromide was dissolved in 200 ml of water while the water was heated, and then the temperature of the solution was increased to 80° C. 2 Milliliters of a styrene monomer were added to the solution and then the mixture was stirred. After that, 0.6 g of azobisisobutyramidine dihydrochloride was added to the mixture. The mixture was stirred for 3 hours without being treated. Thus, a reaction was completed. The particle diameter of part of the reaction liquid was measured with a laser-type particle size distribution meter (Zetasizer Nano S manufactured by Malvern Instruments Ltd.). As a result, it was able to be confirmed that polystyrene particles having a volume-average particle diameter of 23.8 nm and a polydispersity of 0.056 were produced. In addition, part of the particles were dried and observed with an electron microscope. As a result, it was able to be confirmed that spherical polystyrene particles were produced.

Next, 100 ml of the reaction liquid after the completion of the reaction were taken, 18 g of octane and 8.08 g of an aqueous solution of lysine (prepared by dissolving 0.08 g of lysine in 8 g of water) were added thereto, and the mixture was stirred at room temperature. Further, 4.0 g of triethoxymethylsilane were added to the mixture and then the whole was stirred for 40 hours. Thus, silica was deposited on the peripheries of the polystyrene particles to coat the peripheries.

The layer of octane was removed. Thus, an aqueous layer in which such core-shell particles that the peripheries of the polystyrene cores were coated with silica were dispersed was obtained. Further, centrifugation and washing were repeated to remove impurities except the core-shell particles. Thus, a dispersion of the core-shell particles was obtained. The particle diameter of part of the dispersion was measured with a laser-type particle size distribution meter (Zetasizer Nano S manufactured by Malvern Instruments Ltd.). As a result, it was able to be confirmed that core-shell particles having a volume-average particle diameter of 31.4 nm and a polydispersity of 0.045 were produced. In addition, part of the particles were dried and observed with an electron microscope. As a result, it was able to be confirmed that spherical core-shell particles were produced.

### EXAMPLE 1

A micro slide glass (manufactured by Matsunami Glass Ind., Ltd., refractive index: 1.52) was used as a base material. The dispersion of the core-shell particles produced in Production Example 1 was applied to one of its surfaces with a spinner and then dried. A thickness after the drying was 110 nm.

Next, the surface to which the core-shell particles had been applied was irradiated with ultraviolet light. A desktop light surface treatment apparatus PL-16-110 (manufactured by SEN LIGHTS CORPORATION) was mounted with an ultraviolet lamp (a low-pressure mercury lamp SUV 10GS-36 (110 W manufactured by SEN LIGHTS CORPORATION)), and then the micro slide glass to which the core-shell particles had been applied was placed at a position distant from the glass surface of the ultraviolet lamp by 2 cm. The ultraviolet lamp was lit up to perform the irradiation with the ultraviolet light for 1 hour. After that, the glass was taken out of the apparatus. Thus, an antireflection film was produced.

The removal of the polystyrene as a core was confirmed by the transmission mode of an electron microscope. As a result, it was confirmed that the core was removed and hollow particles were obtained. The shapes of the hollow particles were uniform.

### EXAMPLE 2

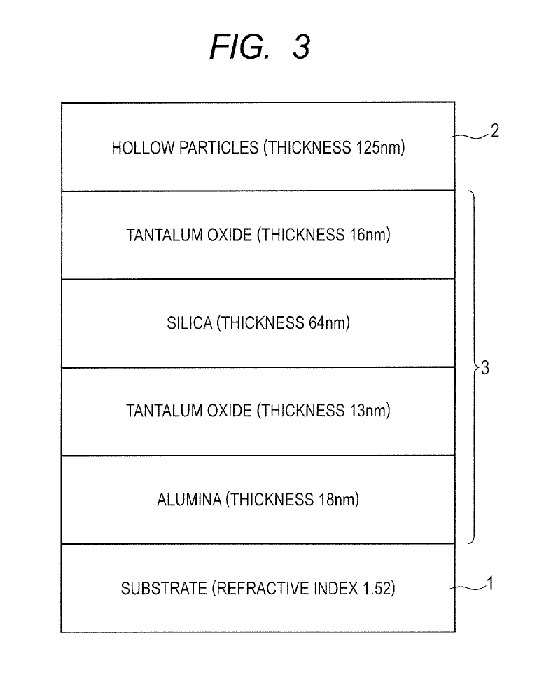

Four layers, i.e., alumina having a thickness of nm (refractive index: 1.63), tantalum oxide having a thickness of 13 nm (refractive index: 2.11), silica having a thickness of 64 nm (refractive index: 1.46), and tantalum oxide having a thickness of 16 nm were laminated on an optical lens having a refractive index of 1.52 as a base material in the stated order. Further, the core-shell particles produced in Production Example 1 were applied onto tantalum oxide so as to have a thickness of 125 nm, and were then dried. An antireflection film was produced by performing irradiation with ultraviolet light as in Example 1. FIG. 3 is an explanatory diagram illustrating an optical element having the antireflection film produced by Example 2.

The removal of the polystyrene as a core was confirmed by the transmission mode of an electron microscope. As a result, it was confirmed that the core was removed and hollow particles were obtained. The shapes of the hollow particles were uniform.

### EXAMPLE 3

An antireflection film was produced in the same manner as in Example 1 except that, in Example 1, the base material was held at 200° C. at the time of the irradiation with the ultraviolet light, and a time period for the irradiation with the ultraviolet light and the holding at 200° C. was set to 20 minutes. The removal of the polystyrene as a core was confirmed by the transmission mode of an electron microscope. As a result, it was confirmed that the core was removed and hollow particles were obtained. The shapes of the hollow particles were uniform.

### EXAMPLE 4

An antireflection film was produced in the same manner as in Example 2 except that, in Example 2, the base material was held at 200° C. at the time of the irradiation with the ultraviolet light, and a time period for the irradiation with the ultraviolet light and the holding at 200° C. was set to 20 minutes. The removal of the polystyrene as a core was confirmed by the transmission mode of an electron microscope. As a result, it was confirmed that the core was removed and hollow particles were obtained. The shapes of the hollow particles were uniform.

### EXAMPLE 5

In Example 1, a solution prepared by diluting methyltriethoxysilane with ethanol to 2 wt % was applied to a gap between the hollow particles in the sample after the irradiation with the ultraviolet light and their surfaces with a spinner, and was then dried. After that, heating was performed at 200° C. for 30 minutes to condense methyltriethoxysilane into silica. Thus, a binder was formed.

The removal of the polystyrene as a core was confirmed by the transmission mode of an electron microscope. As a result, it was confirmed that the core was removed and hollow particles were obtained. The shapes of the hollow particles were uniform.

### EXAMPLE 6

In Example 4, a solution prepared by diluting methyltriethoxysilane with ethanol to 2 wt % was applied to a gap between the hollow particles in the sample after the irradiation with the ultraviolet light and their surfaces with a spinner, and was then dried. After that, heating was performed at 200° C. for 30 minutes to condense methyltriethoxysilane into silica. Thus, a binder was formed.

The removal of the polystyrene as a core was confirmed by the transmission mode of an electron microscope. As a result, it was confirmed that the core was removed and hollow particles were obtained. The shapes of the hollow particles were uniform.

### EXAMPLE 7

An antireflection film was produced in the same manner as in Example 1 except that, in Example 1, the base material was held at 200° C. at the time of the irradiation with the ultraviolet light, and a time period for the irradiation with the ultraviolet light and the holding at 200° C. was set to 30 minutes. The removal of the polystyrene as a core was confirmed by the transmission mode of an electron microscope. As a result, it was confirmed that the core was removed and hollow particles were obtained. The shapes of the hollow particles were uniform.

### COMPARATIVE EXAMPLE 1

The dispersion of the core-shell particles produced in Production Example 1 was substituted with toluene, and then the resultant was left to stand while being stirred for 2 days without being treated. Thus, the polystyrene as a core was dissolved and removed. The remainder was washed by centrifugation to provide a dispersion of hollow particles.

The dispersion was applied to the same base material as that of Example 1 and then dried, provided that no irradiation with ultraviolet light was performed.

### COMPARATIVE EXAMPLE 2

The dispersion of the core-shell particles produced in Production Example 1 was dried and then the core-shell particles were taken out as powder. The polystyrene as a core was removed by calcining the powder at 450° C. for 1 hour. After that, an attempt was made to disperse the powder in toluene. However, the powder could not be dispersed in the solvent because its agglomeration was remarkably observed.

(Evaluation for Reflectance)

The reflectances of the samples produced in the examples and the comparative examples were measured as described below. The surface on which the core-shell particles had been formed into a film was defined as a measuring surface, and then its reflectance in a visible region (corresponding to wavelengths of 400 to 700 nm) was measured with a microspectrophotometer USPM-RUIII manufactured by Olympus Corporation. Table 1 shows a reflectance at a wavelength of 550 nm.

TABLE 1

| | Reflectance at 550 nm (%) |
|---|---|
| Example 1 | 0.13 |
| Example 2 | 0.18 |
| Example 3 | 0.14 |
| Example 4 | 0.18 |
| Example 5 | 0.16 |
| Example 6 | 0.20 |
| Example 7 | 0.31 |
| Comparative Example 1 | 2.50 |
| Comparative Example 2 | Unable to evaluate |

As can be seen from Table 1, Examples 1 to 6 can each be used as an antireflection film because their reflectances are 0.5% or less. The reflectance of Comparative Example 1 is higher than those of the examples because a particle from which it has been unable to remove the polystyrene as a core remains. In addition, Comparative Example 2 could not be evaluated because a dispersion could not be produced owing to remarkable agglomeration of particles.

The present invention can be utilized in an optical element such as a lens or a display because the present invention can produce an antireflection film having a low reflectance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-271394, filed Dec. 12, 2011, which is hereby incorporated by reference herein in its entirety.

What is claimed is:

1. A method of producing an antireflection film provided on a base material, the method comprising:
applying, onto the base material, a dispersion containing core-shell particles each using an organic polymer as a core and silica as a shell;
drying the dispersion to form a film containing the core-shell particles; and
removing the organic polymer through irradiation of the film containing the core-shell particles with ultraviolet light to turn the core-shell particles into hollow particles.

2. The method according to claim 1, wherein at least one optical film having a refractive index of 1.30 or more is laminated on the base material and the dispersion is applied onto the laminated optical film.

3. The method according to claim 1, wherein the dispersion contains a component needed for forming a binder.

4. The method according to claim 1, wherein the irradiation with the ultraviolet light is performed in a state where the base material is held at a temperature of 100° C. or more and 200° C. or less.

5. A lens, comprising an antireflection film produced by the method according to claim 1.

6. A method of producing an antireflection film provided on a base material, the method comprising:
applying, onto the base material, a dispersion containing core-shell particles each using an organic polymer as a core and silica as a shell;
drying the dispersion to form a film containing the core-shell particles;
removing the organic polymer through irradiation of the film containing the core-shell particles with ultraviolet light to turn the core-shell particles into hollow particles; and
applying a solution containing a component needed for forming a binder to fill a gap between the hollow particles with the binder.

7. The method according to claim 6, wherein at least one optical film having a refractive index of 1.30 or more is laminated on the base material and the dispersion is applied onto the laminated optical film.

8. The method of producing an antireflection film according to claim 6, wherein the irradiation with the ultraviolet light is performed in a state where the base material is held at a temperature of 100° C. or more and 200° C. or less.

9. A lens, comprising an antireflection film produced by the method according to claim 6.
